(19) United States
(12) Patent Application Publication
(10) Pub. No.: US 2015/0169264 A1
(43) Pub. Date: Jun. 18, 2015

(54) IMAGE FORMING APPARATUS AND DISPLAY DEVICE

(71) Applicant: Sharp Kabushiki Kaisha, Osaka-shi, Osaka (JP)

(72) Inventor: Masaki Tawada, Osaka-shi (JP)

(21) Appl. No.: 14/408,374

(22) PCT Filed: Aug. 27, 2013
(86) PCT No.: PCT/JP2013/072836

§ 371 Date: Dec. 16, 2014

(30) Foreign Application Priority Data
Sep. 12, 2012 (JP) 2012-200030

(51) Int. Cl. G06F 3/12; H04N 1/00; H04N 1/393; G06K 15/02

(52) U.S. Cl. CPC G06F 3/1212; G06F 3/1285; G06F 3/1268; G06K 15/1872; G06K 15/1886; H04N 1/00129; H04N 1/00209; G06K 15/1809; H04N 1/3935; H04N 2201/0094

(57) ABSTRACT

An image forming apparatus (50) stores read image data obtained by reading a document, display image data generated from the read image data, and image specifying information thereof, and transmits the display image data etc. to a display device (60). Receiving the print instruction having the image specifying information added from the display device (60), the image forming apparatus (50) reads and prints the read image data specified by the image specifying information thereof (step 472). If a modification object is attached to the received data, the modification object and positional information thereof are converted to match the resolution or size of the read image data, and the converted result is combined with the read image data and printed.

### TECHNICAL FIELD

The present invention relates to an image forming apparatus and to a display device and, more specifically, to an image forming apparatus executing printing of an image displayed on a display device as well as to the display device.

### BACKGROUND ART

Assume that an image data read by a multifunctional peripheral is displayed on a display device, and then the image is printed by the multifunctional peripheral. If the display device has an image modifying function, it may be possible that the original image is modified by the display device. No matter whether the image is modified or not, the display device transmits the image data to the multifunctional peripheral and requests printing.

Generally, the resolution of image data displayed on the display device is lower than the resolution of the image data initially read by the multifunctional peripheral. Therefore, when the image transmitted from the display device is printed by the multifunctional peripheral, the output will have lower image quality than has the original image. In order to avoid this, the resolution of the image displayed on the display device may be set higher; however, it follows that the image data of high resolution must be transmitted from the display device to the multifunctional peripheral. This poses a problem that longer transmitting time is required, since the higher the resolution is, the greater the volume of the image data is.

In connection with the problem described above, Patent Literature 1 as specified below discloses a print system in which the image data obtained from an information processing apparatus is immediately transmitted from a display device to a multifunctional peripheral, and every time the image is modified, a modified object is transmitted to the multifunctional peripheral.

### CITATION LIST

### Patent Literature

### Patent Literature 1: Japanese Patent Laying-Open No. 2009-10639

### SUMMARY OF INVENTION

### Technical Problem

According to the print system disclosed in Patent Literature 1, the image data and the modified object are transmitted to the multifunctional peripheral at the same time as these are obtained. Therefore, after the modification is complete and the user instructs printing, printing is done immediately, since the image data and the modified object or objects have already been transmitted to the multifunctional peripheral. If the image displayed on the display device is to be printed by a printing apparatus while maintaining high image quality of the print, however, there remains a problem that the communication traffic cannot be reduced.

From the foregoing, an object of the present invention is to provide an image forming apparatus and a display device allowing printing of an image displayed on the display device with high quality in a time saving manner.

### Solution to Problem

According to a first aspect, the present invention provides an image forming apparatus connected to a display device, including: reading means for reading image data; storage means for storing the image data read by the reading means in association with image specifying information specifying the image data; image data transmitting means for transmitting the image data and the image specifying information thereof stored in the storage means to the display device; and printing means, responsive to reception of a print instruction having the image specifying information attached from the display device, for reading from the storage means and printing the image data specified by the image specifying information.

The image forming apparatus stores the read image data in association with the image specifying information, and transmits the stored image data and the image specifying information of the image data to the display device. Further, when a print instruction with the image specifying information attached is received from the display device, it reads and prints the image data specified by the image specifying information. Specifically, when the image data specified by the image specifying information received from the display device is stored, the image forming apparatus prints not the displayed image data but the corresponding original image data. Therefore, printing with the image quality not of the displayed image data but of the read image data is possible. Further, at the time of printing, the image data is not transmitted to the image forming apparatus. Therefore, the time from when the print instruction is received until the printing ends can be made shorter than when printing is done after the image data is transmitted to the image forming apparatus.

Preferably, the image forming apparatus further includes: determining means for determining whether modification image data to the image is further attached to the print instruction received by the printing means; and image combining means, responsive to a positive determination by the determining means, for combining the image data read by the printing means with the modification image data to form combined image data, before printing is executed by the printing means.

When the modification image data is attached to the print instruction, what is printed is the combined image data obtained by combining the image data to be printed and the modification image data. Therefore, when the image data is somehow modified on the display device, it is possible for the user to get the printout that reflects the result of modification, without necessitating any special operation.

More preferably, the modification image data includes an image object, generated in the display device, superposed on the image data as an object of printing; and the image combining means generates the combined image data by combining the image data read by the printing means with image data of the image object, before printing is executed.

The image data as the object of printing is combined with the image represented by the image object. The image object is generated superposed on the image data and, therefore, the image of modified object is superposed and reflected on the resulting, printed image. Therefore, the same image as the image reflecting the modification made on the display device can be printed.

More preferably, information related to resolution or size is added to each of the image data stored in the storage means; and information related to resolution or size of the image data of the image object when displayed on the display device is further attached to the print instruction. Based on resolution or size of the image data as an object of printing read by the printing means and on the resolution or size of the image data of the image object when displayed on the display device, attached to the print instruction, the image combining means converts the resolution or size of the image object to match the resolution or size of the image data as the object of printing read from the storage means by the printing means, and combines the image data as the object of printing with the image data of the image object after conversion, before printing is executed.

The resolution or size of the object is converted from the resolution or size when the object has been displayed on the display device to the resolution or size matching the resolution or size of the read image data to be printed. After the conversion, the object is combined with the image data to be printed. Therefore, the resolution or size of the object matches the resolution or size of the image data to be printed, and hence, the image reflecting the modification can be printed with the image quality kept high.

According to a second aspect, the present invention provides a display device connected to an image forming apparatus capable of reading and storing document data, including: image data receiving means for receiving image data and image specifying information of the image data from the image forming apparatus; storage means for storing the image data and the image specifying information in association with each other; display means for displaying the image data; input receiving means for receiving an instruction input for printing the image data displayed on the display means; and print instruction transmitting means, responsive to reception of the instruction input by the input receiving means, for transmitting a print instruction having the image specifying information stored in the storage means in association with the image data displayed on the display means attached, to the image forming apparatus.

The display device stores the image data received from the image forming apparatus and the image specifying information in association with each other. Further, when a print instruction of the displayed image data is received, it transmits the print instruction having the image specifying information corresponding to the image data attached, to the image forming apparatus. Since the display device does not transmit the image data, the time necessary for the transmission can be reduced than when the image data itself is transmitted.

Preferably, the display device further includes: modifying means for receiving an input of a modification image to the image displayed on the display means and for storing the modification image in the storage means. The print instruction transmitting means includes: determining means, responsive to reception of the instruction input by the input receiving means, for determining whether or not a modification image is stored for the image displayed on the display means; and means for selectively executing, depending on whether the result of determination by the determining means is positive or negative, a process of transmitting a print instruction having both the image specifying information stored in the storage means in association with the image data displayed on the display means and the modification image attached, to the image forming apparatus, or a process of transmitting a print instruction having the image specifying information stored in the storage means in association with the image data displayed on the display means, to the image forming apparatus.

When the displayed image is modified, the display device stores the modification. When a modification instruction is received, if there is a modified image, a print instruction having both the modified image and the image specifying information attached is transmitted to the image forming apparatus, and if there is no modified image, a print instruction having only the image specifying information attached is transmitted. Therefore, even when a displayed image is modified, it is possible for the user to get the print image with the modification reflected, by simply inputting a normal print operation instruction, without necessitating any special operation.

More preferably, the modification image includes information related to an image object added by the modification means to the image data.

The image object added to the display screen of the display device is transmitted as the modified image to the image forming apparatus, and combined with the image data to be printed. Therefore, it is possible for the user to print the same image as the image displayed on the display screen with the image object added.

More preferably, the display means displays the image data in a prescribed resolution or size; and the print instruction transmitting means transmits the print instruction additionally having information representing the prescribed resolution or size when displayed by the display means attached, to the image forming apparatus.

On the display means, the image data of a prescribed resolution or size is displayed. By setting the prescribed resolution or size in advance to match the resolution or size of the display device, the time necessary for the display process can be reduced.

### Advantageous Effects of Invention

According to the present invention, when the data is transmitted from the display device to the image forming apparatus, the print instruction having the image specifying information is transmitted, and the image data is not transmitted. Therefore, the time necessary for transmitting the data from the display device to the image forming apparatus can be reduced than when the image data is also transmitted. As a result, the time from when the user inputs the print instruction until the printing ends can be reduced than conventionally required. Further, since the image forming apparatus reads and prints the image data specified by the image specifying information attached to the print instruction, printing with the image quality of the read image data becomes possible. As described above, by the present invention, it is possible to print the image displayed on the display apparatus in a short time, while maintaining high image quality.

### BRIEF DESCRIPTION OF DRAWINGS

FIG. 1 shows a schematic configuration of a print system in accordance with a first embodiment of the present invention.

FIG. 2 shows an electric configuration of the image forming apparatus shown in FIG. 1.

FIG. 3 shows an electric configuration of the display device shown in FIG. 1.

FIG. 4 is a flowchart representing a control structure of a computer program executed when a document is read by the image forming apparatus in accordance with the first embodiment.

FIG. 5 is a flowchart representing a control structure of a computer program executed when image data and image specifying information are received by the display device in accordance with the first embodiment.

FIG. 6 is a flowchart representing a control structure of a computer program executed when a print instruction is detected by the image forming apparatus in accordance with the first embodiment.

FIG. 7 is a flowchart representing a control structure of a computer program executed when a print instruction is received by the image forming apparatus in accordance with the first embodiment.

FIG. 8 shows a screen image displayed on the display device.

FIG. 9 shows image data displayed on the display device.

FIG. 10 shows a modification made on the image of FIG. 9.

FIG. 11 is a flowchart representing a control structure of a computer program executed when a print instruction is detected by the image forming apparatus in accordance with a second embodiment.

FIG. 12 is a flowchart representing a control structure of a computer program executed when a print instruction is received by the image forming apparatus in accordance with the second embodiment.

### DESCRIPTION OF EMBODIMENTS

In the following description and in the drawings, the same components are denoted by the same reference numerals. Therefore, detailed description thereof will not be repeated.

### First Embodiment

### Schematic Configuration of Print System

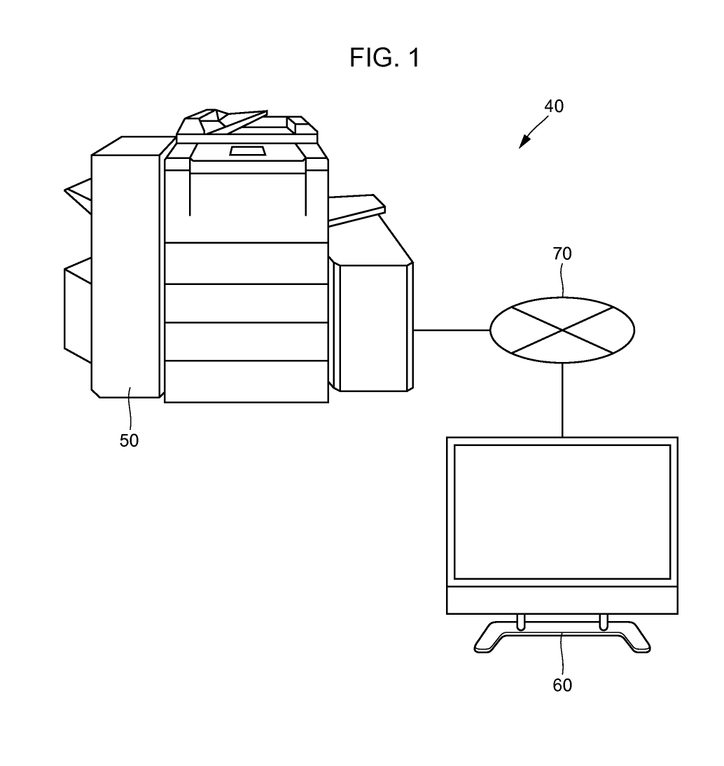

Referring to FIG. 1, a print system 40 in accordance with the present embodiment includes an image forming apparatus 50, a display device 60, and a network line 70 connecting these. Though image forming apparatus 50 is a so-called multifunctional peripheral, it may be a printer or the like.

<Hardware Configuration>

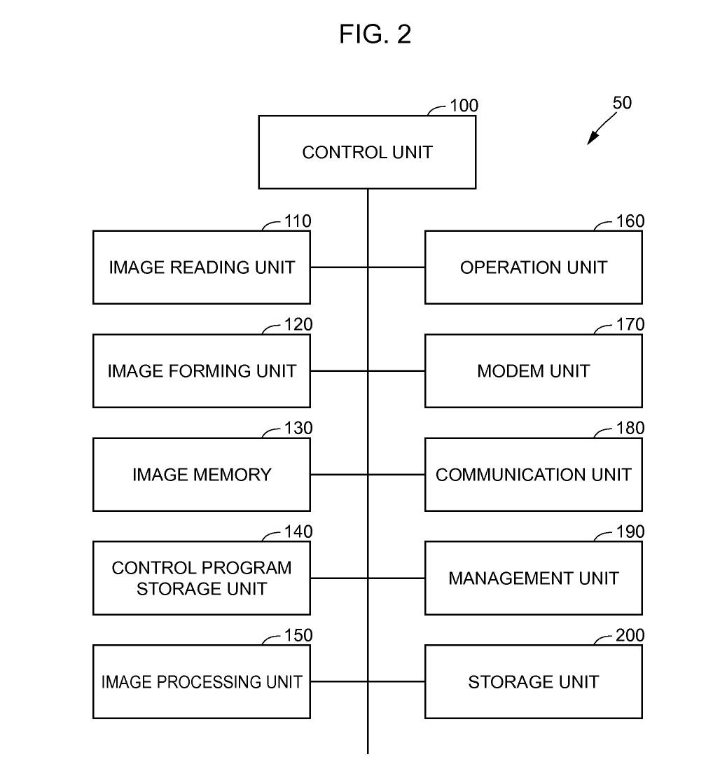

Referring to FIG. 2, image forming apparatus 50 includes: a control unit 100 for controlling various functional units; an image reading unit 110 reading image data from a document; an image forming unit 120 forming an image on a recording medium; an image memory 130 storing image data read by image reading unit 110; a control program storage unit 140 storing various control programs related to image forming apparatus 50; an image processing unit 150 processing image data; an operation unit 160 for operating image forming apparatus 50; a modem unit 170 for analog/digital conversion; a communication unit 180 for communication with an external device connected to image forming apparatus 50; a management unit 190 for generating image specifying information for specifying image data read by image reading unit 110, managing settings of image forming apparatus 50, and managing jobs executed by image forming apparatus 50; and a storage unit 200 storing information related to the image data stored in image memory 130.

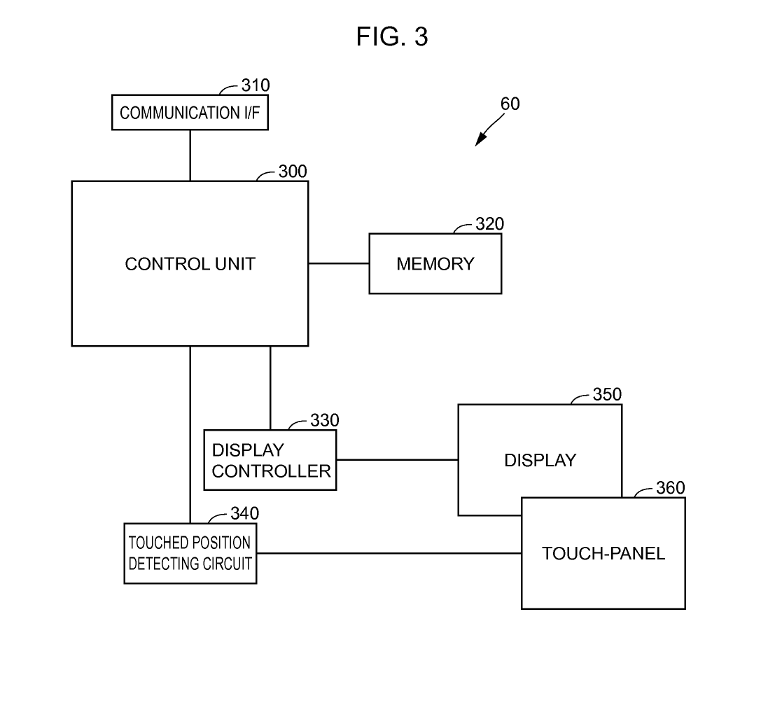

Referring to FIG. 3, display device 60 includes: a control unit 300 controlling various functional units; a communication interface 310 (hereinafter denoted as communication I/F 310) for enabling communication with an external device connected to display device 60; a memory 320 storing image data received by display device 60 and information related to the image data; a display 350 displaying the image data; a display controller 330, connected to control unit 300, for controlling display 350; a touch-panel 360 for detecting an instruction input by a user; and a touched position detecting circuit 340 connected to control unit 300 for detecting a touched position of the input detected by touch-panel 360.

Memory 320 also stores information related to the settings of display device 60. The user may change settings of display device 60 as desired, by operating touch-panel 360 and an input unit, not shown.

In the present embodiment, display 350 and touch-panel 360 are formed as a so-called integrated touch-panel display. Touched position detecting circuit 340 can detect what position on touch-panel 360 is operated by the user, and control unit 300 determines what instruction is input, in accordance with the detected position. Further, control unit 300 causes various functional units to execute a process in accordance with the input instruction.

<Software Configuration>

Referring to FIGS. 1 to 7, the control structures of programs executed by image forming apparatus 50 and display device 60, when image data read by image forming apparatus 50 is transmitted to display device 60, the image data is displayed on display device 60 and thereafter the image data is printed, will be described.

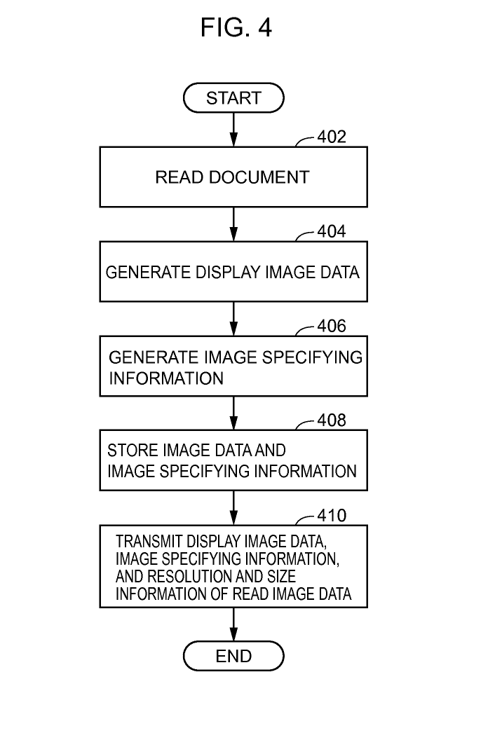

The program shown in FIG. 4 is executed by image forming apparatus 50, and the program starts when an operation of reading a document is detected. The program includes: a step 402 of reading image data from a document by image reading unit 110; a step 404 of generating display image data to be displayed on display device 60 from the read image data read at step 402; a step 406 of generating image specifying information for specifying the read image data; a step 408 of storing the image data and the image specifying information generated through steps 402 to 406 in association with each other in image memory 130 and in storage unit 200, respectively; and a step 410 of transmitting the display image data stored in image memory 130, the image specifying information corresponding to the display image data, and information related to resolution and size of the read image data corresponding to the display image data to display device 60. When the process of step 410 ends, execution of the program ends.

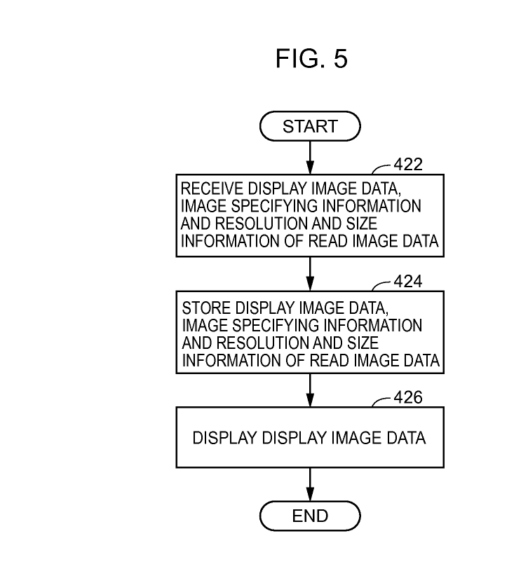

The program shown in FIG. 5 is executed by display device 60, and the program starts when any data is received from image forming apparatus 50. The program includes: a step 422 of receiving the display image data, the image specifying information corresponding to the display image data, and the information related to the resolution and size of the read image data, from image forming apparatus 50; a step 424 of storing the series of data received at step 422 in memory 320; and a step 426 of displaying the display data on display 350. When the process at step 426 ends, execution of the program ends.

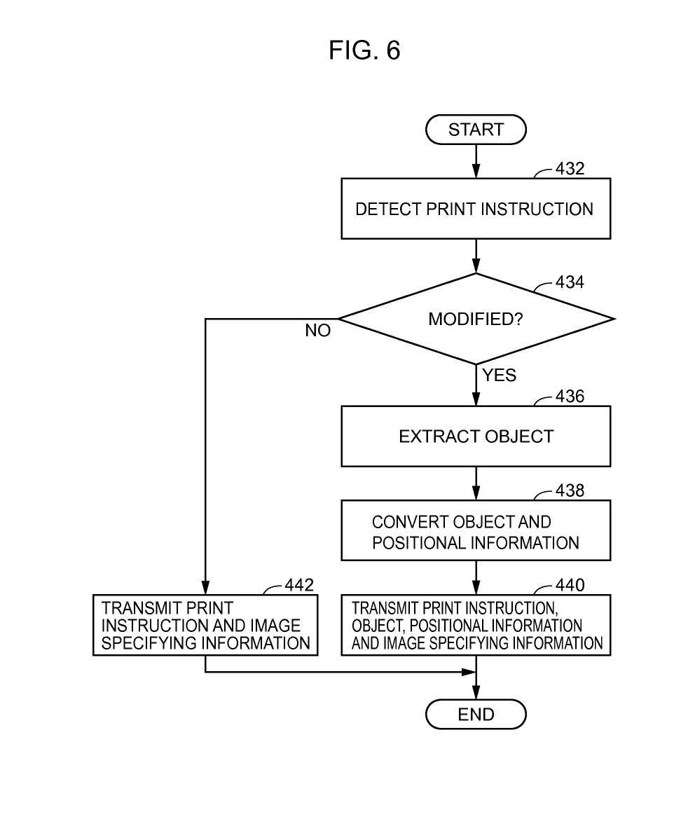

The program shown in FIG. 6 is executed by display device 60, and the program starts when a print instruction instructing printing of the image displayed on display 350 is detected. The program includes: a step 432 of detecting a print instruction; a step 434 of determining whether or not modification image data to the image as the object of printing is input; a step 436, executed in response to a positive determination at step 434, of extracting an object of the modified portion from the modification image data; a step 438 of converting the object extracted at step 436 and positional information of the object to match the read image data in accordance with resolution or size of the read image data; a step 440 of transmitting the print instruction, the object, the positional information of the object, and the image specifying information of the image data to image forming apparatus 50; and a step 442, executed in response to a negative determination at step 434, of transmitting the print instruction and the image specifying information of the image data to be printed to image forming apparatus 50. When the process of step 440 or 442 ends, execution of the program ends.

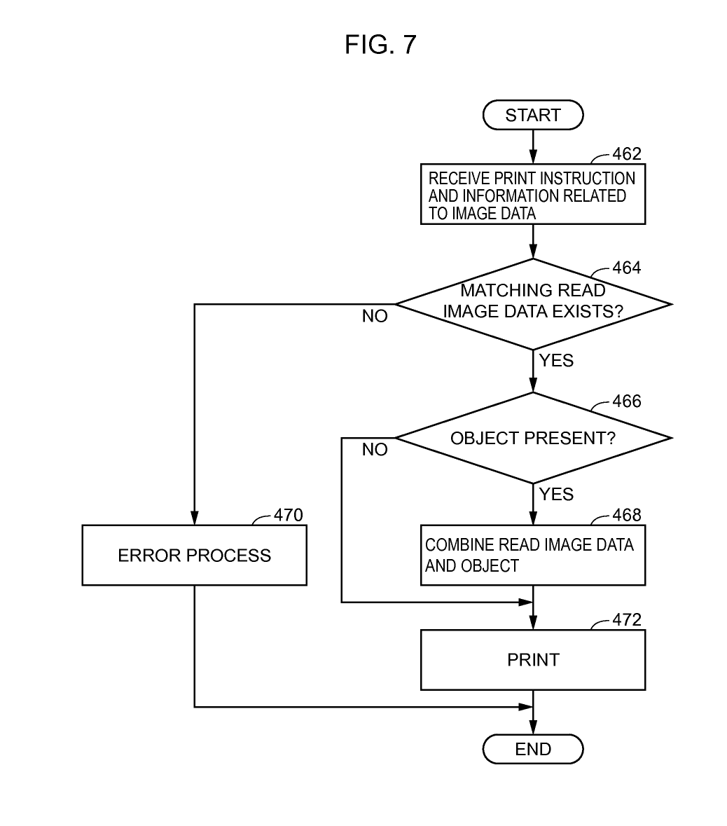

The program shown in FIG. 7 is executed by image forming apparatus 50, and the program starts when a print instruction is received from display device 60. The program includes: a step 462 of receiving the print instruction and the like from display device 60; a step 464 of determining whether the read image data specified by the image specifying information attached to the print instruction received at step 462 is stored in image memory 130; a step 466, executed in response to a positive determination at step 464, of determining whether or not an object is attached to the received print instruction; a step 468, executed in response to a positive determination at step 466, of reading the read image data confirmed at step 464 to be stored, from image memory 130, and combining the same with the object; a step 472 of printing the combined image data; and a step 470, executed in response to a negative determination at step 464, of executing a prescribed error processing. If the result of determination at step 466 is negative, the control proceeds to step 472. If the process at step 470 or 472 ends, execution of the program ends.

<Operation>

Referring to FIGS. 2 to 10, an operation when image data read by image forming apparatus 50 is transmitted to display device 60, the image data is displayed on display device 60 and thereafter the image data is printed, will be described.

When a user operates operation unit 160 and inputs an instruction to read a set document, control unit 100 reads the document, generates read image data, and stores the data in image memory 130 (step 402). At step 404, control unit 100 causes image processing unit 150 to generate display image data to be displayed on display device 60, based on the read image data. The display image data is generated to be the image data matching the resolution or size of display device 60 set in advance by the user. Generally, the display resolution of a display device is considerably lower than the print resolution of the image forming apparatus. Therefore, when the display image data is printed by the image forming apparatus, the image quality is considerably lower than when the read image data is printed. On the other hand, in data communication, if the resolution is low, the data amount becomes smaller accordingly and, therefore, the time necessary for transmitting the display image data is shorter than the time necessary for transmitting the read image data.

At step 406, control unit 100 causes management unit 190 to generate image specifying information for specifying the read image data. The read image data and the display image data are stored in image memory 130, and the image specifying information specifying the image data is stored in storage unit 200 (step 408).

At step 410, control unit 100 transmits the display image data, the image specifying information specifying the image data, and the information related to the resolution or size of the read image data through communication unit 180 to display device 60. The image data transmitted here is the image data with the resolution or size converted, to be displayed on the display device. The data amount of display image data is smaller than the read image data and, therefore, it can be transmitted in a shorter time period than will be required when the read image data is transmitted.

When communication I/F 310 receives the display image data, the image specifying information and the information related to the resolution and size of the read image data (step 422), control unit 300 stores the series of received data in memory 320 (step 424).

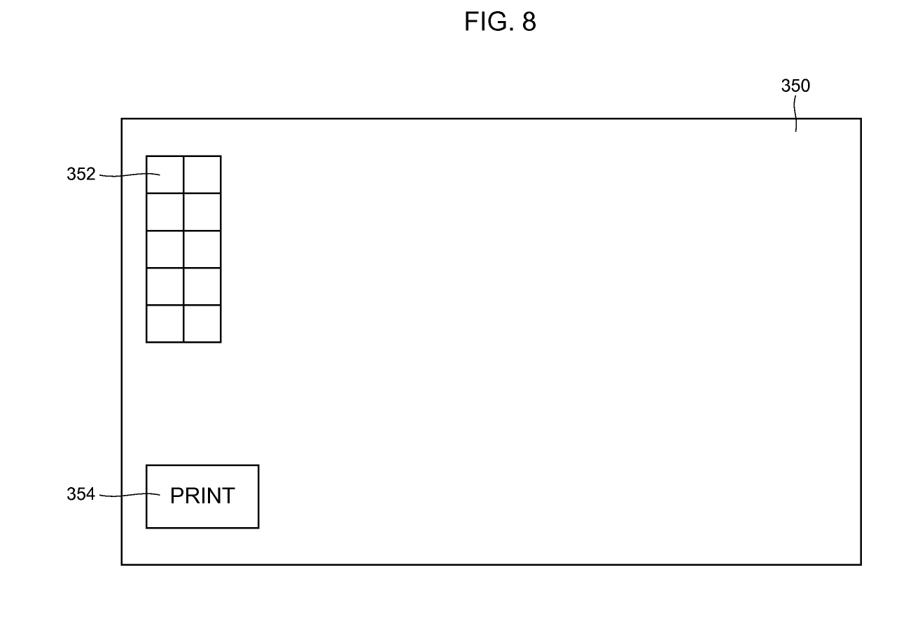

Display 350 shown in FIG. 8 is in a state in which no image data is displayed, and nothing is displayed at the central portion. Displayed on the left end of display are a group of icons 352 as a set of functional icons allowing setting of various functions related to the display, and a print start key 354 to start printing of the image displayed on display 350. By touching positions where the group of icons 352 and print start key 354 are displayed with his/her bare finger or with a touch-pen, the user can cause the display device to execute a process corresponding to each of the functions.

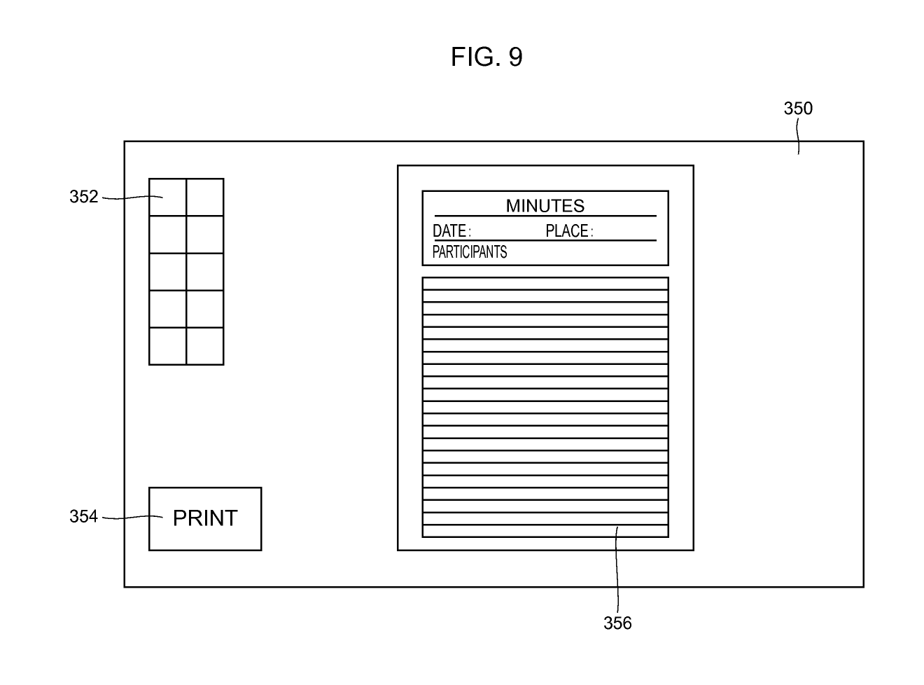

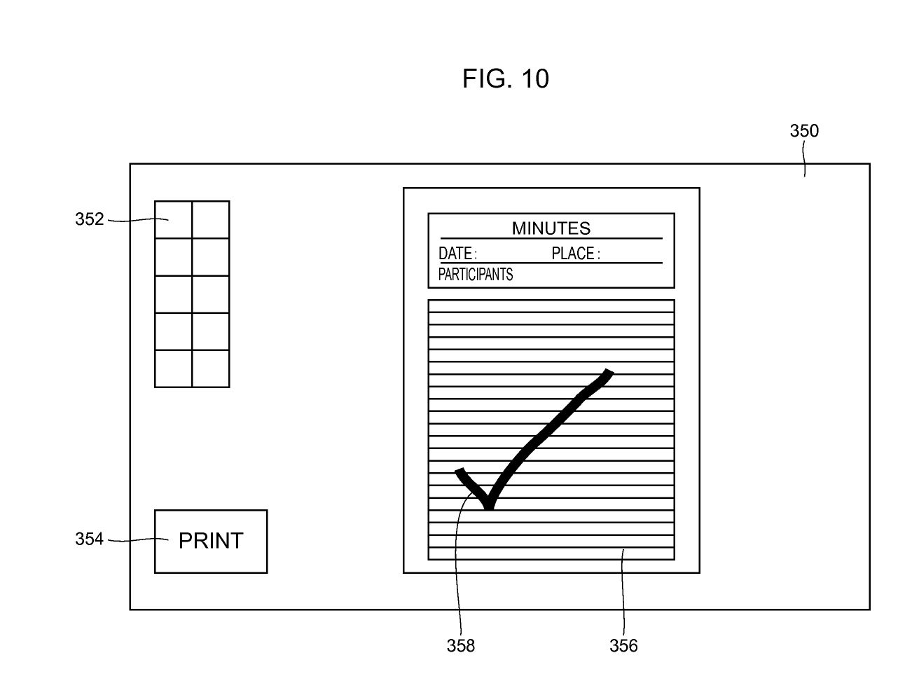

At step 426, control unit 300 controls display controller 330 such that the received image data is displayed on display 350. Referring to FIG. 9, at the central portion of display 350, an image 356 is displayed. By touching or tracing the portion where image 356 is displayed, it is possible for the user to enter inputs, for example, to write, to image 356. A modified image 358 shown in FIG. 10 represents the image added by the user. Since modified image 358 is displayed superposed on image 356, the image displayed on the display screen is just like the image printed on paper with a memorandum written on it with a pen or the like. Each added image is saved as an image object, in the memory. Each image object has display position, display color, display size and image data as its attribute data.

When the user touches print start key 354, control unit 300 detects a print instruction (step 432), and determines whether or not any modification has been added to the image displayed on display 350, or whether or not an image object representing a modification to the image is stored in the memory. If there is any modification (YES at step 434), control unit 300 reads the image object (step 436), and based on the image object, converts the image data and the positional information and the resolution or size of the image object to match the resolution or size of the read image data received from image forming apparatus 50 (step 438). Control unit 300 transmits the print instruction, the converted image object, the converted positional information and the image specifying information specifying the display image data through communication I/F 310 to image forming apparatus 50 (step 440). If there is no modification (NO at step 434), control unit 300 transmits the print instruction and the image specifying information through communication I/F 310 (step 442).

Upon receiving the print instruction, the image specifying information and the like from display device 60 (step 462), control unit 100 determines whether or not the read image data specified by the received image specifying information exists in image memory 130. If the corresponding read image data exists (YES at step 464), control unit 100 determines whether or not the print instruction received from display device 60 has data of image object attached. If the data of image object is attached (YES at step 466), control unit 100 reads the corresponding read image data from image memory 130, combines the same with the image data of the image object (step 468), and causes image forming unit 120 to print the combined image data (step 472). Specifically, the image data of the image object is superposed on the display position of the image object on the read image data, and the image after superposition is displayed. If the image data specified by the received image specifying information does not exist (NO at step 464), control unit 100 executes a prescribed error processing (step 470). The error processing may be a process of transmitting an error message to the display device. If the read image data specified by the image specifying information exists but the received data does not have any object data attached (YES at step 464 and NO at step 466), control unit 100 reads the corresponding read image data from image memory 130 and causes image forming unit 120 to print the same.

<Effects>

As described above, by the print system in accordance with the first embodiment, when a print instruction is given with respect to the image displayed on the display device, image forming apparatus 50 reads the read image data specified by the image specifying information received together with the print instruction from the display device from image memory 130 and prints the same. The image to be printed has the resolution when it is read from the document and, therefore, the image can be printed with the image quality maintained. Further, the data transmitted from display device 60 to image forming apparatus 50 is information related to the image data to be printed, not the image data itself. Therefore, as compared with the time required for transmitting the image data itself, the time for transmitting data to the image forming apparatus can be shortened. As a result, the time when the user inputs a print instruction on the display device until the printing ends can be made shorter than when the display image data is transmitted and printed. The modification object is printed after the display position, size, resolution and the like are converted to match the read image data and, therefore, the image quality is not much degraded even when it is superposed on the read image data.

### Second Embodiment

The print system in accordance with the second embodiment differs from the print system in accordance with the first embodiment in that the process of converting the object data is executed not by the display device but by the image forming apparatus. Except for this point, the print systems have the same configurations.

<Software Configuration>

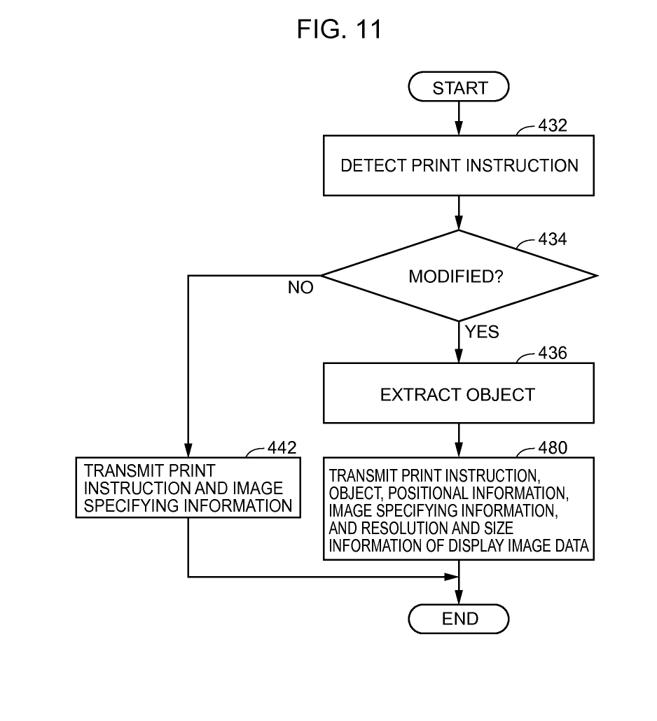

In the image forming apparatus in accordance with the second embodiment, in place of the program shown in FIG. 6, the program shown in FIG. 11 is executed. The program of FIG. 11 includes, in place of steps 438 and 440 of FIG. 6, a step 480 of transmitting a print instruction, an image object, positional information of the image object, image specifying information for specifying display image data displayed on display 350, and information related to the resolution and size of the display image data, to image forming apparatus 50.

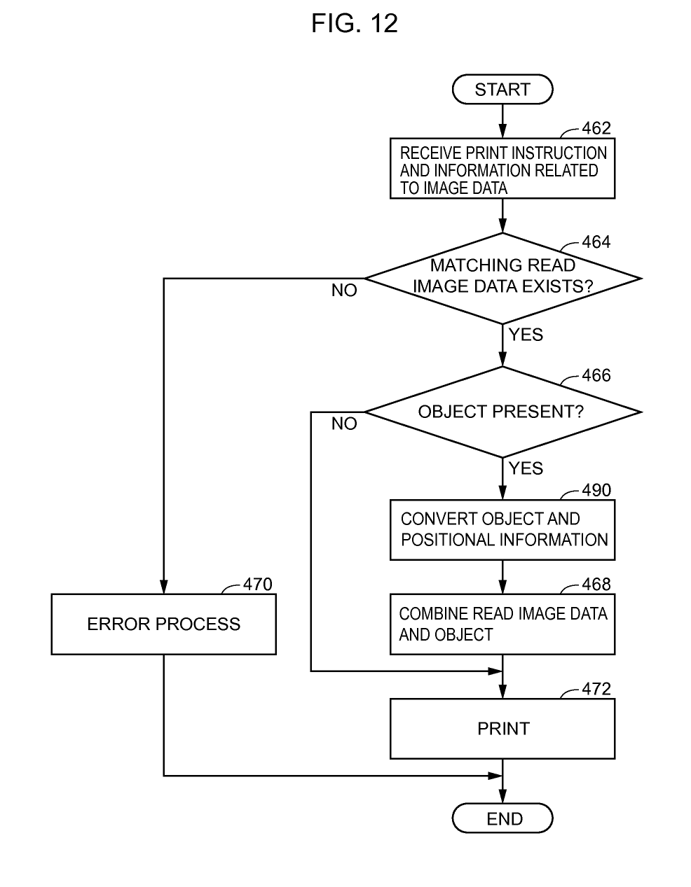

Similarly, in the display device in accordance with the second embodiment, in place of the program shown in FIG. 7, the program of FIG. 12 is executed. The program of FIG. 12 includes a step 490 executed immediately before step 468 if the determination at step 466 of FIG. 7 is positive, of converting the image object and the positional information of the image object in accordance with the resolution or size of the read image data.

<Effects>

By the present embodiment, as is the case with the first embodiment, it is possible to print the read image data specified by the image specifying information. Further, since the display image data is not transmitted from the display device to the image forming apparatus, the time necessary to complete printing can be reduced compared with the time required to transmit the data before printing.

Though image forming apparatus 50 is a multifunctional peripheral in the embodiments above, it may be any apparatus other than the multifunctional peripheral provided that it has a function of reading an image, a function of forming an image on a recording medium and a function of data transmission/reception to/from a connected external device. By way of example, it may be a copy machine, a printer or the like. Similarly, display device 60 may be any display device provided that it has a function of displaying image data, a function of providing an input to displayed image data, and a function of data transmission/reception to/from a connected external device. Though display device 60 is a touch-panel display with a communication I/F, the display and the input device may be configured separately.

Though image forming apparatus 50 and display device 60 are connected by network line 70 as a wired line, these may be directly connected to each other without using any network line. Alternatively, data may be exchanged between the apparatus and the device by means of wireless communication.

Though one image forming apparatus and one display device are used in the embodiments above, two or more of the apparatuses and devices may be used. By way of example, a configuration may be possible in which a plurality of display devices are installed, a plurality of modification data input by the display devices to the same image data may be superposed on the read image data stored in the image forming apparatus, and the image data reflecting all modification data may be printed.

The image specifying information may be in any form, provided that it can specify the image data. By way of example, a unique ID may be added to a header portion of the image data when a document is read.

In the embodiments above, when the object converting process takes place in the image forming apparatus, the information related to the resolution or size of display image data is transmitted to the image forming apparatus. The information related to the resolution or size may be set arbitrarily by the user and may be stored in the image forming apparatus in advance. By such an approach, it becomes unnecessary to transmit the information related to the resolution or size to the image forming apparatus and, therefore, the time necessary for the transmission process can be reduced.

Though the image data transmitted to the display device is display image data in the embodiments above, the data may be the read image data, or image data converted to match the desired resolution or size. If it is desired to display an image of high quality on the display device, it is preferable to transmit the read image data. If the time necessary for transmitting image data is to be reduced, image data with its resolution made lower may be transmitted.

In the embodiment above, the processes for transmitting modification image data, conversion and combining are executed after the print instruction is received. These processes, however, may be executed before receiving the print instruction. By way of example, a configuration may be possible in which every time the display image data displayed on the display device is modified, the process of combining the modified image data based on the modification with the read image data is executed on real time basis in the image forming apparatus, and simultaneously with the input of print instruction, the combined image data is printed. This configuration can further reduce the time from the input of print instruction until the completion of printing.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

The present invention provides an image forming apparatus and a display device allowing printing of an image displayed on the display device in a short time without sacrificing image quality.

### REFERENCE SIGNS LIST

50 image forming apparatus
60 display device
100, 300 control unit
130 image memory
150 image processing unit
200 storage unit
320 memory
350 display
360 touch-panel

1. An image forming apparatus connected to a display device, comprising:
an image data reader configured or programmed to read image data;
a display image data generator configured or programmed to generate image data to be displayed from read image data read by said image data reader;
a storage configured or programmed to store the read image data read by said image data reader in association with the display image data generated from the read image data and with image specifying information specifying the read image data;
an image data transmitter configured or programmed to transmit the display image data stored in the storage and the image specifying information stored in association with the display image data to said display device; and
a printer configured or programmed to, responsive to reception of a print instruction having the image specifying information attached from said display device, read from said storage and print the read image data specified by said image specifying information.

2. The image forming apparatus according to claim 1, further comprising:
a determining controller configured or programmed to determine whether modification image data to the image is further attached to said print instruction received by said printer; and
an image combiner configured or programmed to, responsive to a positive determination by said determining controller, combine said read image data read by said printer with said modification image data to form combined image data, before printing is executed by said printer.

3. The image forming apparatus according to claim 2, wherein
said modification image data includes an image object, generated in said display device, superposed on the display image data stored in association with the read image data as an object of printing; and
said image combiner is configured or programmed to generate said combined image data by combining said read image data read by said printer with image data of said image object, before printing is executed.

4. The image forming apparatus according to claim 3, wherein
information related to resolution or size is added to each of the image data stored in said storage;
information related to resolution or size and positional information of the image data of said image object when displayed on said display device is further attached to said print instruction; and
based on resolution or size of the read image data as an object of printing read by said printer and on the resolution or size of the image data of said image object when displayed on said display device, attached to said print instruction, said image combiner configured or programmed to convert the resolution or size of said image object and the positional information of said image object to match the resolution or size of the read image data as the object of printing read from said storage by said printer, and to combine said read image data as the object of printing with the image data of said image object after conversion, based on the positional information of said image object after conversion, before printing is executed.

5. A display device connected to an image forming apparatus capable of reading and storing document data, comprising:
an image data receiver configured or programmed to receive display image data and image specifying information of the display image data from said image forming apparatus;
a storage configured or programmed to store said display image data and said image specifying information in association with each other;
a display configured or programmed to display said display image data;
an input receiver configured or programmed to receive an instruction input for printing the display image data displayed on said display; and
a print instruction transmitter configured or programmed to, responsive to reception of said instruction input by said input receiver, transmit a print instruction having the image specifying information stored in said storage in association with said display image data displayed on said display attached, to said image forming apparatus.

6. The display device according to claim 5, further comprising:
a modifier configured or programmed to receive an input of a modification image to the image displayed on said display and to store the modification image in said storage; wherein
said print instruction transmitter includes:
a determining controller configured or programmed to, responsive to reception of said instruction input by said input receiver, determine whether or not a modification image is stored for the display image displayed on said display, and
a selective executing controller configured or programmed to selectively execute, depending on whether the result of determination by said determining controller is positive or negative, a process of transmitting a print instruction having both said image specifying information stored in said storage in association with the display image data displayed on said display and said modification image attached, to said image forming apparatus, or a process of transmitting a print instruction having said image specifying information stored in said storage in association with the display image data displayed on said display attached, to said image forming apparatus.

7. The display device according to claim 6, wherein said modification image includes information related to an image object added by said modifier to said image data.

8. The display device according to claim 5, wherein
said display is configured or programmed to display said display image data in a prescribed resolution or size; and
said print instruction transmitter is configured or programmed to transmit said print instruction, additionally including information representing said prescribed resolution or size when displayed by said display attached, to said image forming apparatus.
